(19) United States
(12) Patent Application Publication
(10) Pub. No.: US 2026/0262591 A1
(43) Pub. Date: Sep. 10, 2026

(54) PLANT MANAGEMENT APPARATUS, PLANT MANAGEMENT METHOD, AND NON-TRANSITORY COMPUTER READABLE MEDIUM

(71) Applicant: Yokogawa Electric Corporation, Tokyo (JP)

(72) Inventors: Emiko HATSUGAI, Tokyo (JP); Junshan WANG, Tokyo (JP); Hirari SATOU, Tokyo (JP)

(21) Appl. No.: 19/166,466

(22) PCT Filed: Mar. 7, 2024
(86) PCT No.: PCT/JP2024/008828

§ 371 Date: Sep. 17, 2025

(30) Foreign Application Priority Data
Mar. 24, 2023 (JP) 2023-047677

(51) Int. Cl. A01G 31/06; A01G 31/00

(52) U.S. Cl. CPC A01G 31/06; A01G 31/011

(57) ABSTRACT

A plant management apparatus may include an environmental control unit which controls, for at least one cultivation rack, environment of a plurality of cultivation racks for cultivating a plant in a plant factory by controlling environmental control equipment which controls an environmental state in the plant factory. The plant management apparatus may include a receiving unit which receives information indicating a harvest time of the plant. The plant management apparatus may include a selection unit which, based on environmental control information indicating a relationship between a growth period and an environmental control condition of the environmental control equipment, selects, as a target cultivation rack, at least one cultivation rack which satisfies a condition of the harvest time from among the plurality of cultivation racks in which the plant is cultivated in environment controlled by the environmental control equipment under respective environmental control conditions.

### TECHNICAL FIELD

The contents of the following patent application(s) are incorporated herein by reference:
NO. 2023-047677 filed in JP on Mar. 24, 2023

The present invention relates to a plant management apparatus, a plant management method, and a program.

### BACKGROUND

Patent Document 1 discloses a cultivation method comprising the steps of: preparing correspondence information obtained by associating light characteristic information indicating the characteristics of light irradiating leafy vegetables with quantified quality information quantifying the quality of leafy vegetables; setting the optical characteristic information; and irradiating the leafy vegetables with light.

### RELATED ART DOCUMENTS

### Patent Documents

Patent Document 1: Japanese Patent Application Publication No. 2022-13560

### GENERAL DISCLOSURE

### Technical Problem

When a plant is cultivated in a plant factory, a system that can take account of a quality of the plant, in addition to a harvest time and a yield of the plant, to select an appropriate environmental control condition, is desired.

### Solution to Problem

A plant management apparatus according to one aspect of the present invention may include an environmental control unit which controls, for at least one cultivation rack, environment of a plurality of cultivation racks for cultivating a plant in a plant factory by controlling environmental control equipment which controls an environmental state in the plant factory. The plant management apparatus may include a receiving unit which receives information indicating a harvest time of the plant. The plant management apparatus may include a selection unit which, based on environmental control information indicating a relationship between a growth period and an environmental control condition of the environmental control equipment, selects, as a target cultivation rack, at least one cultivation rack which satisfies a condition of the harvest time from among the plurality of cultivation racks in which the plant is cultivated in environment controlled by the environmental control equipment under respective environmental control conditions. The plant may be a vegetable, a fruit, or a fresh flower. The plant may be at least one of the vegetable, the fruit, or the fresh flower.

In the plant management apparatus, when no cultivation rack which satisfies the condition of the harvest time exists, based on the environmental control information, the selection unit may select, as the target cultivation rack, at least one cultivation rack in which the growth period is able to be adjusted to satisfy the condition of the harvest time by changing the environmental control condition. The environmental control unit may control the environmental control equipment under the environmental control condition being changed, to change the environment of the target cultivation rack.

In any of the plant management apparatuses, the receiving unit may receive the information further indicating a yield of the plant to be harvested in the harvest time. The selection unit may select, as the target cultivation rack, at least one cultivation rack which satisfies conditions of the harvest time and the yield, from among the plurality of cultivation racks.

In any of the plant management apparatuses, when no cultivation rack which satisfies the conditions of the harvest time and the yield exists, based on the environmental control information, the selection unit may select, as target cultivation rack, the at least one cultivation rack in which at least one of the growth period and the yield is able to be adjusted to satisfy the conditions of the harvest time and the yield by changing the environmental control condition. The environmental control unit may control the environmental control equipment under the environmental control condition being changed, to change the environment of the target cultivation rack.

In any of the plant management apparatuses, the receiving unit may receive the information further indicating a quality of the plant in addition to the yield of the plant to be harvested in the harvest time. Based on the environmental control information which further indicates the quality of the plant in addition to the growth period and the yield, the selection unit may select, as the target cultivation rack, at least one cultivation rack which satisfies conditions of the harvest time, the yield, and the quality, from among the plurality of cultivation racks.

In any of the plant management apparatuses, when at least one cultivation rack which satisfies the conditions of the harvest time, the yield, and the quality does not exist, based on the environmental control information, the selection unit may select, as the target cultivation rack, at least one cultivation rack in which at least one of the growth period, the yield, or the quality is able to be adjusted to satisfy the conditions of the harvest time, the yield, and the quality by changing the environmental control condition. The environmental control unit may control the environmental control equipment under the environmental control condition being changed, to change the environment of the target cultivation rack. When the environmental control equipment is controlled to shorten the harvest time, the selection unit may evaluate a quality of the plant as lower by a predetermined rate according to a number of days by which the harvest time of the plant is shortened, determine whether the quality of the plant being evaluated satisfies the condition of the quality, and select, as the target cultivation rack, at least one cultivation rack capable of satisfying the conditions of the harvest time, the yield, and the quality. When the environmental control equipment is controlled to lengthen the harvest time, the selection unit may evaluate the quality of the plant as higher by a predetermined rate according to a number of days by which the harvest time of the plant is lengthened, determine whether the quality of the plant being evaluated satisfies the condition of the quality, and select, as the target cultivation rack, at least one cultivation rack capable of satisfying the conditions of the harvest time, the yield, and the quality. When the environmental control equipment is controlled to shorten the harvest time, the selection unit may evaluate a quality of the plant as higher by a predetermined rate according to a number of days by which the harvest time of the plant is shortened, determine whether the quality of the plant being evaluated satisfies the condition of the quality, and select, as the target cultivation rack, at least one cultivation rack capable of satisfying the conditions of the harvest time, the yield, and the quality. When the environmental control equipment is controlled to lengthen the harvest time, the selection unit may evaluate the quality of the plant as lower by a predetermined rate according to a number of days by which the harvest time of the plant is lengthened, determine whether the quality of the plant being evaluated satisfies the condition of the quality, and select, as the target cultivation rack, at least one cultivation rack capable of satisfying the conditions of the harvest time, the yield, and the quality.

In any of the plant management apparatuses, when at least one cultivation rack which satisfies the condition of the harvest time does not exist, the selection unit may select, as a candidate cultivation rack, a cultivation rack in which a harvest time closest to the condition of the harvest time is scheduled, and then select the candidate cultivation rack as the target cultivation rack when a number of days by which the harvest time of the candidate cultivation rack is to be changed to satisfy the condition of the harvest time is within a predetermined number of days which are adjustable by changing the environmental control condition.

In any of the plant management apparatuses, the quality may include at least one of a size, a taste, or a shade of color of the plant.

In any of the plant management apparatuses, the environmental control condition may include a control condition of at least one of a temperature in the plant factory or an amount of light of a light source that radiates light to the plant. The environmental control condition may indicate an hourly set condition of the temperature in the plant factory, and an hourly set condition of the light source during the growth period of the plant.

A plant management method according to one aspect of the present invention may include controlling, by an environmental control unit and for at least one cultivation rack, environment of a plurality of cultivation racks for cultivating a plant in a plant factory by controlling environmental control equipment which controls an environmental state in the plant factory. The plant management method may include receiving, by a receiving unit, information indicating a harvest time of the plant. The plant management method may include selecting, by a selection unit and based on environmental control information indicating a relationship between a growth period and an environmental control condition of the environmental control equipment, at least one cultivation rack which satisfies a condition of the harvest time, as a target cultivation rack, from among the plurality of cultivation racks in which the plant is cultivated in environment controlled by the environmental control equipment under respective environmental control conditions.

A program according to one aspect of the present invention may cause a computer to perform controlling, for at least one cultivation rack, environment of a plurality of cultivation racks for cultivating a plant in a plant factory by controlling environmental control equipment which controls an environmental state in the plant factory. The program may cause the computer to perform receiving information indicating a harvest time of the plant. The program may cause the computer to perform selecting, based on environmental control information indicating a relationship between a growth period and an environmental control condition of the environmental control equipment, at least one cultivation rack which satisfies a condition of the harvest time, as a target cultivation rack, from among the plurality of cultivation racks in which the plant is cultivated in environment controlled by the environmental control equipment under respective environmental control conditions.

The summary clause does not necessarily describe all necessary features of the embodiments of the present invention. The present invention may also be a sub-combination of the features described above.

### BRIEF DESCRIPTION OF THE DRAWINGS

FIG. 1 is a diagram showing an example of a functional block of an overall configuration of a plant management system according to the present embodiment.

FIG. 2 is a diagram showing an example of a functional block of a plant management apparatus.

FIG. 3 is a diagram showing an example of environmental control condition information.

FIG. 4 is a diagram for describing an example of an adjustment method of a harvest time.

FIG. 5 is a flowchart showing an example of a procedure for selecting a cultivation rack that satisfies a harvest time, a yield, and a quality requested.

FIG. 6 is a diagram showing an example of a hardware configuration.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention.

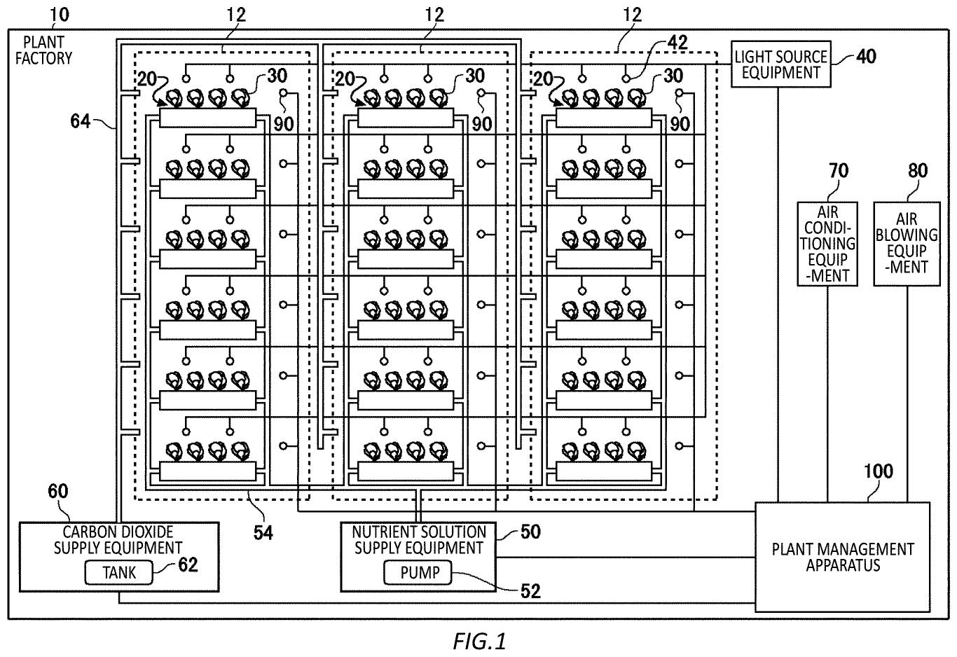

FIG. 1 is a diagram showing an example of a functional block of an overall configuration of a plant management system according to the present embodiment. The plant management system manages a growth state of a plant 30 that is cultivated in a plant factory 10. The plant management system includes a plurality of cultivation racks 20, light source equipment 40, nutrient solution supply equipment 50, carbon dioxide supply equipment 60, air conditioning equipment 70, air blowing equipment 80, a sensor 90, and a plant management apparatus 100. The light source equipment 40, the nutrient solution supply equipment 50, the carbon dioxide supply equipment 60, the air conditioning equipment 70, and the air blowing equipment 80 are examples of environmental control equipment. Hereinafter, the light source equipment 40, the nutrient solution supply equipment 50, the carbon dioxide supply equipment 60, the air conditioning equipment 70, and the air blowing equipment 80 may collectively referred to as environmental control equipment.

The cultivation rack 20 cultivates the plant 30 such as a vegetable, a fruit, or a fresh flower. By shifting a sowing date for each set of one or more cultivation racks 20, adjustments are performed such that the plants 30 can be harvested at harvest times different from each other. In addition, by each of the one or more cultivation racks 20 being installed in a separate space 12 for the plurality of cultivation racks 20, and by an environment in the space 12 being individually controlled by the environmental control equipment, the plant 30 may be cultivated in a different environmental state for each space. The space 12 may be a space in which heat insulation and airtightness are high. In the present embodiment, the plant management apparatus 100 individually controls the environmental state for each set of the cultivation racks 20. However, the plant management apparatus 100 may individually control the environmental state of each of a plurality of shelves included in one cultivation rack 20.

The light source equipment 40 includes a plurality of light sources 42 such as LEDs or incandescent lamps that radiate artificial light, and radiates the artificial light to the plant 30 from each of the plurality of light sources 42. The plurality of light sources 42 may be arranged to face a cultivation surface of the cultivation rack 20.

The nutrient solution supply equipment 50 has a pump 52 and a pipe 54, and supplies, to the cultivation rack 20 via the pump 52 and the pipe 54, a nutrient solution containing each of fertilizer components such as potassium or calcium. The nutrient solution supply equipment 50 appropriately adjusts a fertilizer concentration, and supplies, to the plant 30, the nutrient solution with the adjusted fertilizer concentration. The nutrient solution supply equipment 50 may supply the nutrient solution to the plant 30 by atomizing the nutrient solution with the adjusted fertilizer concentration and spraying the atomized nutrient solution onto a root part of the plant 30. The nutrient solution supply equipment 50 may function as irrigation equipment that supplies water to a medium in which the plant 30 is cultivated. An amount of irrigation that is supplied to the cultivation rack 20 may be adjusted by adjusting an amount of the nutrient solution that is supplied to the cultivation rack 20 from the nutrient solution supply equipment 50.

The carbon dioxide supply equipment 60 has a tank 62 and a nozzle 64. The tank 62 stores carbon dioxide. The carbon dioxide supply equipment 60 supplies carbon dioxide stored in the tank 62, to each space 12 in the plant factory 10 via the nozzle 64.

The air conditioning equipment 70 controls a temperature and humidity of an air in the plant factory 10, and circulates the air of which the temperature and the humidity are controlled, into each space. The air blowing equipment 80 includes a circulator or a fan that supplies a wind into the plant factory 10. The sensor 90 includes various types of sensors that measure the environmental state around the plant 30 and the growth state of the plant 30. The sensor 90 includes various types of sensors that respectively measure the temperature, the humidity, an amount of light, and a carbon dioxide concentration of stem, leaf, and fruit portions of the plant 30.

The plant management apparatus 100 controls the growth state of the plant 30 by controlling the light source equipment 40, the nutrient solution supply equipment 50, the carbon dioxide supply equipment 60, the air conditioning equipment 70, and the air blowing equipment 80. The plant management apparatus 100 communicates with the light source equipment 40, the nutrient solution supply equipment 50, the carbon dioxide supply equipment 60, the air conditioning equipment 70, and the air blowing equipment 80, via a wireless network or a wired network.

The plant management apparatus 100 may be a computer having a central processing unit (CPU) and a memory. The light source equipment 40, the nutrient solution supply equipment 50, the carbon dioxide supply equipment 60, the air conditioning equipment 70, and the air blowing equipment 80 may include the computers having the central processing units (CPU) and the memories.

The computer may be a computer such as a personal computer, a tablet type computer, a smartphone, a workstation, a server computer, or a general purpose computer, or may be a computer system in which a plurality of computers are connected. Such a computer system is also a computer in a broad sense. The computer may be a dedicated computer designed for an environmental control of a plant factory, or may be dedicated hardware realized by dedicated circuitry. The computer may be implemented by a virtual computer environment. When the computer is used, the plant management apparatus 100, the light source equipment 40, the nutrient solution supply equipment 50, the carbon dioxide supply equipment 60, the air conditioning equipment 70, and the air blowing equipment 80 are realized by executing a program by the computer.

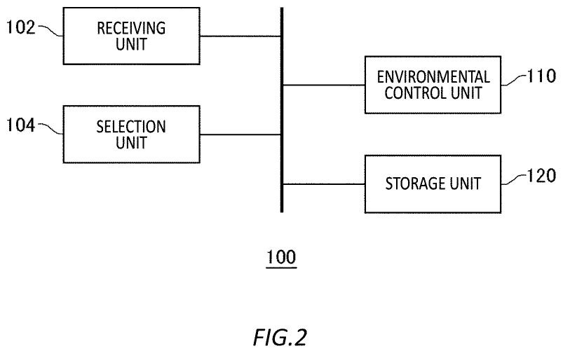

In the plant management system configured in this way, it is desirable to be able to cultivate the plant 30 by changing the environmental control condition of the environmental control equipment to satisfy the requested harvest time.
FIG. 2 is a diagram showing an example of a functional block of the plant management apparatus 100. The plant management apparatus 100 includes a receiving unit 102, a selection unit 104, an environmental control unit 110, and a storage unit 120.

The receiving unit 102 receives information indicating the harvest time of the plant 30. The receiving unit 102 may receive, from a request source of the plant 30, information indicating the harvest time of the plant 30. The request source may be a terminal that transmits information in accordance with an instruction from a supplier of the plant 30. The receiving unit 102 may receive information further indicating the yield of the plant 30 to be harvested in the harvest time. The receiving unit 102 may receive information further indicating the quality of the plant 30, in addition to the yield of the plant 30. That is, the receiving unit 102 may receive, from the request source, information indicating the conditions of the harvest time, the yield, and the quality of the plant 30.

Based on the environmental control information indicating a relationship between a growth period and the environmental control condition of the environmental control equipment, the selection unit 104 selects, as the target cultivation rack 20, at least one cultivation rack 20, which satisfies the condition of the harvest time, from among a plurality of cultivation racks 20 in which the plants 30 are cultivated in the environment controlled by the environmental control equipment under the respective environmental control conditions. When at least one cultivation rack 20 which satisfies the condition of the harvest time does not exist, based on the environmental control information, the selection unit 104 may select, as a target cultivation rack, at least one cultivation rack 20 in which the growth period can be adjusted to satisfy the condition of the harvest time by changing the environmental control condition. The growth period is a time from the start of cultivation of the plant 30 on the cultivation rack 20 to the harvest. The environmental control condition indicates a control condition for controlling an operation of each environmental control equipment. The environmental control condition may include the control condition of at least one of the temperature in the plant factory 10, or the amount of light of the light source 42 that radiates the light to the plant 30. The environmental control condition may indicate an hourly set condition of the temperature in the plant factory 10, and an hourly set condition of the light source 42 during the growth period of the plant 30.

When the receiving unit 102 receives the information indicating the harvest time and the yield, the selection unit 104 may select, as the target cultivation rack 20 for the request source, at least one cultivation rack 20, which satisfies the conditions of the harvest time and the yield, from among the plurality of cultivation racks 20. When at least one cultivation rack 20 which satisfies the conditions of the harvest time and the yield does not exist, based on the environmental control information, the selection unit 104 may select, as the target cultivation rack 20, at least one cultivation rack 20 in which at least one of the growth period or the yield can be adjusted to satisfy the conditions of the harvest time and the yield by changing the environmental control condition.

When the receiving unit 102 receives the information indicating the harvest time, the yield, and the quality, based on the environmental control information further indicating the quality of the plant 30 in addition to the growth period and the yield, the selection unit 104 may select, as the target cultivation racks 20,at least one cultivation rack 20, which satisfies the conditions of the harvest time, the yield, and the quality, from among the plurality of cultivation racks 20. When at least one cultivation rack 20 which satisfies the conditions of the harvest time, the yield, and the quality does not exist, based on the environmental control information, the selection unit 104 may select, as the target cultivation rack 20, at least one cultivation rack 20 in which at least one of the growth period, the yield, or the quality can be adjusted to satisfy the conditions of the harvest time, the yield, and the quality by changing the environmental control condition.

By controlling the environmental control equipment, the environmental control unit 110 controls the environment of the plurality of cultivation racks 20 for at least one cultivation rack 20. By controlling at least one of the light source equipment 40, the nutrient solution supply equipment 50, the carbon dioxide supply equipment 60, the air conditioning equipment 70, or the air blowing equipment 80, the environmental control unit 110 controls the environment of the plurality of cultivation racks 20 for at least one cultivation rack 20. The environmental control unit 110 may change the environment of the target cultivation rack 20 by controlling the environmental control equipment under the environmental control condition changed in order to adjust at least one of the growth period, the yield, or the quality.

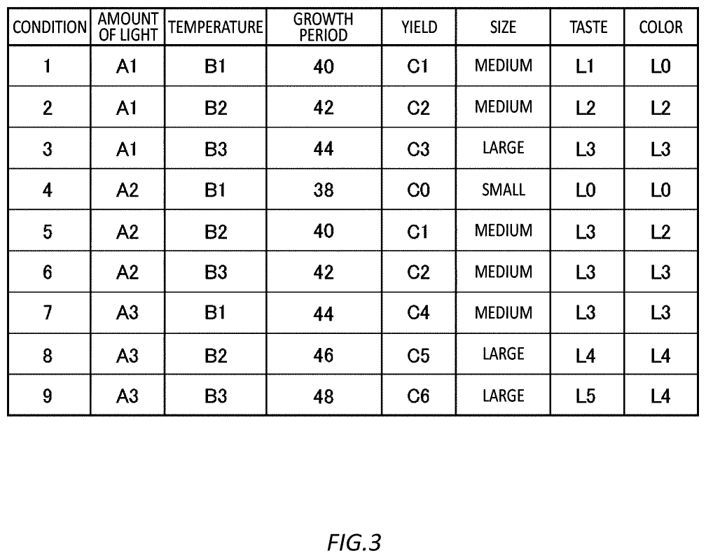

The environmental control condition may include the control condition of at least one of the temperature (the temperature of the control target space) in the plant factory 10, or the amount of light of the light source 42 that radiates the light to the plant 30. The environmental control condition information may be, for example, information as shown in FIG. 3. That is, the environmental control condition information may indicate a condition of the amount of light of the light source 42 of the control target space, a condition of the temperature of the control target space, and the growth period, the yield, the size, the taste, and the shade of color of the plant 30, for each environmental control condition. The condition of the amount of light of the light source 42 may indicate the condition of the amount of light for each stage obtained by dividing the growth period into a plurality of stages. The condition of the amount of light of the light source 42 may indicate, for example, the time and the amount of light per day for irradiating the plant 30 with the light source 42. The condition of the temperature may indicate the condition of the temperature for each stage of the growth period. The condition of the temperature may indicate, for example, the temperature of each time zone of one day. The size may indicate the size of the plant 30, for example, by indexes of three levels. The taste may indicate a degree of taste of the plant 30, for example, in five levels. The shade of color may indicate a degree of the shade of color of the plant 30 in three levels. Each index of the quality is not limited to the above, and may be appropriately set according to the type of the plant 30 and the like.

The growth period, the yield, the size, the taste, and the shade of color included in the environmental control condition information may be generated by changing the environmental control condition for each stage of the growth period and actually cultivating the plant 30 in each cultivation rack 20 of the plant factory 10, and by evaluating a cultivation result thereof; and be stored in the storage unit 120.

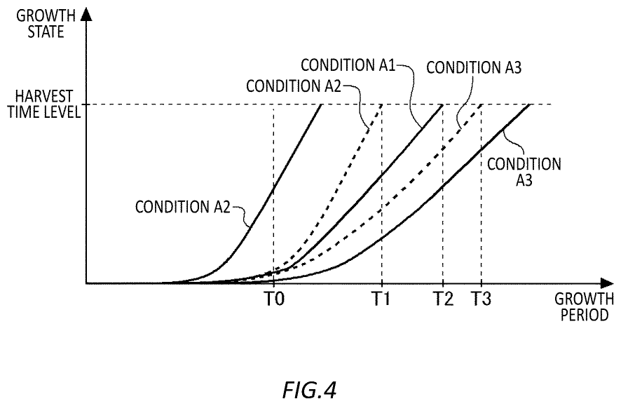

As shown in FIG. 4, in a case where the cultivation rack 20 which satisfies the condition of the harvest time does not exist, but the cultivation rack 20 of a condition A1 that the harvest time is T2 exists, when the environmental control condition from a current time point T0 is changed from the condition A1 to a condition A2 or a condition A3 so that the harvest time is changed from T2 to T1 earlier than T2 or T3 later than T2, so as to satisfy the condition of the harvest time, the selection unit 104 selects the cultivation rack 20. Then, by changing the environmental control condition from the condition A1 to the condition A2 or the condition A3 at the current time point TO, so as to satisfy the condition of the harvest time, the environmental control unit 110 control the environmental control equipment.

For example, when the plant 30 is a variety such as a leaf lettuce, the environmental control unit 110 may control, in order to set the growth period to be shorter than the current growth period, the air conditioning equipment 70 such that the temperature is higher than that during the current growth period. The environmental control unit 110 may control, in order to set the growth period to be longer than the current growth period, the air conditioning equipment 70 such that the temperature is lower than that during the current growth period.

Alternatively, the environmental control unit 110 may control, in order to set the growth period to be shorter than the current growth period, the light source equipment 40 such that the amount of light is greater than that during the current growth period. The environmental control unit 110 may control, in order to set the growth period to be longer than the current growth period, the light source equipment 40 such that the amount of light is smaller than that during the current growth period.

When at least one cultivation rack 20 which satisfies the condition of the harvest time does not exist, the selection unit 104 may be select, as a candidate cultivation rack 20, the cultivation rack 20 in which a harvest time closest to the condition of the harvest time is scheduled. Further, the selection unit 104 may derive the number of days by which the harvest time of the candidate cultivation rack 20 is to be changed to satisfy the condition of the harvest time. When the number of days is within a predetermined number of days which are adjustable by changing the environmental control condition, the selection unit 104 may select the candidate cultivation rack 20 as the target cultivation rack 20. The environmental control unit 110 may control the air conditioning equipment 70 and the light source equipment 40 in order to adjust at least one of the temperature or the amount of light by a predetermined rate according to the number of days by which the harvest time is changed.

When the current harvest time is shortened, the selection unit 104 may evaluate the quality of the plant 30 as lower by a predetermined rate according to the number of days by which the harvest time of the plant 30 is shortened, and determine whether the condition of the quality is satisfied. The superiority or inferiority of the quality of the plants 30, which changes by shortening or lengthening the harvest time, differs depending on the type of the plants 30.

Therefore, the selection unit 104 may evaluate the quality of the plant 30 as higher by a predetermined rate according to the number of days by which the harvest time of the plant 30 is shortened, and determine whether the condition of the quality is satisfied. In addition, when the current harvest time is lengthened, the selection unit 104 may evaluate the quality of the plant 30 as the same as the current quality or as higher by a predetermined rate according to the number of days to be lengthened, and determine whether the condition of the quality is satisfied.

Alternatively, when the current harvest time is lengthened, the selection unit 104 may evaluate the quality of the plant 30 as the same as the current quality or as lower by a predetermined rate according to the number of days to be lengthened, and determine whether the condition of the quality is satisfied. The rate may be generated by changing the environmental control condition and actually cultivating the plant 30 in each cultivation rack 20 of the plant factory 10, and by evaluating a cultivation result thereof; and be stored in the storage unit 120.

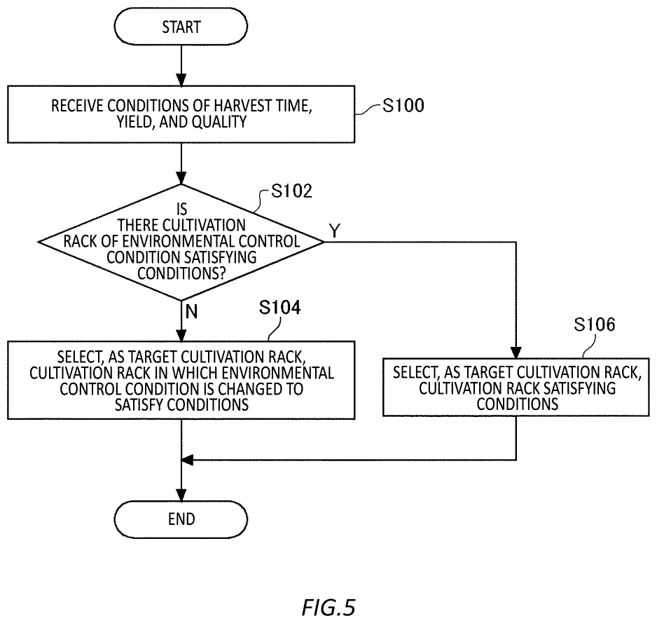

FIG. 5 is a flowchart showing an example of a procedure for selecting the cultivation rack that satisfies the harvest time, the yield, and the quality requested.

The receiving unit 102 receives, from the request source, information indicating the desired conditions of the harvest time, the yield, and the quality of the target plant 30 (S100).

Based on the environmental control information and the environmental control condition of each current cultivation rack 20, the selection unit 104 determines whether the cultivation rack 20 which satisfies the received conditions exists (S102). When the cultivation rack 20 which satisfies the condition exists, the selection unit 104 selects, as the target cultivation rack 20, the cultivation rack 20 which satisfies the condition (S106).

On the other hand, when the cultivation rack 20 which satisfies the condition does not exist, based on the environmental control information, the selection unit 104 may select, as the target cultivation rack, at least one cultivation rack 20 in which at least one of the growth period, the yield, or the quality can be adjusted to satisfy the conditions of the harvest time, the yield, and the quality by changing the environmental control condition (S104).

Hereinbefore, in the plant management apparatus 100 according to present embodiment, the cultivation rack 20 which meets the condition of the requested harvest time is selected from among the plurality of cultivation racks 20 which cultivate the plants 30 in the plant factory 10.

Further, when the cultivation rack 20 which satisfies the condition of the requested harvest time does not exist, the environmental control conditions of the cultivation racks 20 are changed individually to satisfy the requested condition of the cultivation time. Therefore, it is possible to provide the plant 30 more reliably in the harvest time which satisfies the condition of the request. In addition to the harvest time, at least one of the yield and or the quality is further taken into account so that the plant 30 which satisfies the condition of the request can be provided at an appropriate timing.

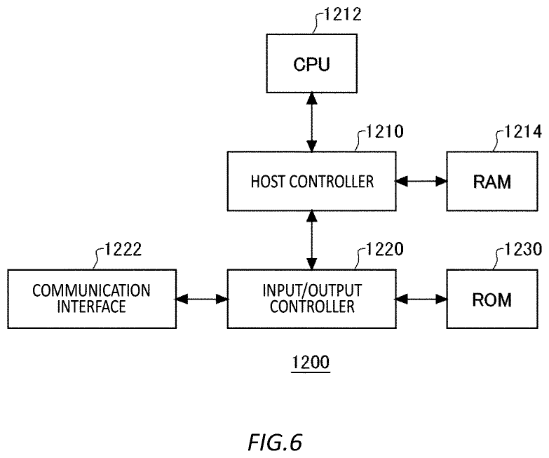

FIG. 6 shows an example of a computer 1200 in which an aspect of the present embodiment may be entirely or partially embodied. Programs installed in the computer 1200 can cause the computer 1200 to function as operations associated with the apparatus according to the embodiments of the present invention or one or more “units” of the apparatus. Alternatively, the programs can cause the computer 1200 to execute the operations or the one or more “units”. The programs can cause the computer 1200 to execute a process according to the embodiments of the present invention or steps of the process. Such programs may be executed by a CPU 1212 to cause the computer 1200 to perform specific operations associated with some or all of the blocks in the flowcharts and block diagrams described in the present specification.

The computer 1200 according to the present embodiment includes the CPU 1212 and a RAM 1214, which are mutually connected by a host controller 1210. The computer 1200 also includes a communication interface 1222 and an input/output unit, which are connected to the host controller 1210 via an input/output controller 1220. The computer 1200 also includes a ROM 1230. The CPU 1212 operates according to the programs stored in the ROM 1230 and the RAM 1214, thereby controlling each unit.

The communication interface 1222 communicates with other electronic devices via a network. A hard disk drive may store the programs and data used by the CPU 1212 in the computer 1200. The ROM 1230 stores therein boot programs or the like executed by the computer 1200 at the time of activation, and/or stores programs depending on hardware of the computer 1200. The programs are provided via a computer readable storage medium such as CR-ROM, a USB memory or an IC Card, or a network. The programs are installed on the RAM 1214, which also is an example of the computer readable storage medium, or the ROM 1230 and performed by the CPU 1212. Information processing written in these programs is read by the computer 1200, and provides cooperation between the programs and the various types of hardware resources described above. An apparatus or a method may be configured by implementing operations or processing of information according to a use of the computer 1200.

For example, in a case where a communication is performed between the computer 1200 and an external device, the CPU 1212 may execute a communication program loaded in the RAM 1214 and instruct the communication interface 1222 to perform communication processing based on a process written in the communication program. Under the control of the CPU 1212, the communication interface 1222 reads transmission data which is stored in the RAM 1214 or a transmission buffer region which is provided in a storage media such as a USB memory, to transmit the read transmission data to the network or write the reception data received from the network into a reception buffer region or the like provided on the storage media.

Also, the CPU 1212 may cause the whole or required part of files which are stored in the external storage media (such as USB memory) or the database to be read by the RAM 1214, to perform a various type of processes for the data on the RAM 1214. Then, the CPU 1212 may write back the processed data to the external storage media.

A various type of information such as a various type of programs, data, tables and databases may be stored in a storage media to undergo information processing. The CPU 1212 may execute, on the data read from the RAM 1214, various types of processing including various types of operations, information processing, conditional judgement, conditional branching, unconditional branching, information retrieval/replacement, or the like described throughout the present disclosure and specified by instruction sequences of the programs, to write the results back to the RAM 1214. Also, the CPU 1212 may retrieve information in the file, database, or the like in the storage media. For example, when a plurality of entries each having an attribute value of the first attribute associated with an attribute value of the second attribute are stored in a storage media, the CPU 1212 may retrieve, among the plurality of entries, an entry whose attribute value of the first attribute is specified and matches the conditions and read the attribute value of the second attribute stored in the entry, thereby acquiring the attribute value of the second attribute associated with the first attribute which satisfies a predetermined condition.

The programs or software module described above may be stored on the computer 1200 or in a computer readable storage medium near the computer 1200. In addition, a storage medium such as a hard disk or a RAM provided in a server system connected to a dedicated communication network or the Internet can be used as a computer readable storage media, thereby providing the program to the computer 1200 via the network.

A computer readable medium may include any tangible device that can store instructions to be executed by a suitable device. As a result, the computer readable medium having instructions stored therein includes an article of manufacture including instructions which can be executed to create means for performing operations specified in the flowcharts or block diagrams. Examples of the computer readable medium may include an electronic storage medium, a magnetic storage medium, an optical storage medium, an electromagnetic storage medium, a semiconductor storage medium, and the like. Specific examples of the computer readable medium may include a floppy (Registered Trademark) disk, a diskette, a hard disk, a random access memory (RAM), a read-only memory (ROM), an erasable programmable read-only memory (EPROM or Flash memory), an electrically erasable programmable read-only memory (EEPROM (Registered Trademark)), a static random access memory (SRAM), a portable compact disc read-only memory (CD-ROM), a digital versatile disc (DVD), a Blu-ray (registered trademark) disc, a memory stick, an integrated circuit card, or the like.

The computer readable instructions may include either source code or object code written in any combination of one or more programming languages. The source code or the object code includes a conventional procedural programming language. The conventional procedural programming language may be assembler instructions, instruction-set-architecture (ISA) instructions, machine instructions, machine dependent instructions, microcode, firmware instructions, state-setting data, or an object oriented programming language such as Smalltalk (registered trademark), JAVA (registered trademark), C++, etc., and programming languages, such as the “C” programming language or similar programming languages. The computer readable instructions may be provided to a processor of a general purpose computer, special purpose computer, or other programmable data processing device, or to programmable circuitry, locally or via a local area network (LAN), a wide area network (WAN) such as the Internet, etc. The processor or the programmable circuitry may execute the computer readable instructions in order to create means for performing operations specified in the flowcharts or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the above described embodiments. It is apparent to persons skilled in the art that various alterations or improvements can be made to the above described embodiments. It is also apparent from the description of the claims that embodiments added with such alterations or improvements can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### DESCRIPTION OF REFERENCE NUMERALS

10: plant factory;
20 cultivation rack;
30: plant;
40: light source equipment;
42: light source;
50: nutrient solution supply equipment;
52: pump;
54: pipe;
60: carbon dioxide supply equipment;
62: tank;
64: nozzle;
70: air conditioning equipment;
80: air blowing equipment;
90: sensor;
100: plant management apparatus;
102: receiving unit;
104: selection unit;
110: environmental control unit;
120: storage unit;
1200: computer;
1210: host controller;
1212: CPU;
1214: RAM;
1220: input/output controller;
1222: communication interface;
1230: ROM.

1. A plant management apparatus comprising a processor, wherein the processor:
controls, for at least one cultivation rack, environment of a plurality of cultivation racks for cultivating a plant in a plant factory by controlling environmental control equipment which controls an environmental state in the plant factory;
receives information indicating a harvest time of the plant; and
based on environmental control information indicating a relationship between a growth period and an environmental control condition of the environmental control equipment, selects, as a target cultivation rack, at least one cultivation rack which satisfies a condition of the harvest time from among the plurality of cultivation racks in which the plant is cultivated in environment controlled by the environmental control equipment under respective environmental control conditions.

2. The plant management apparatus according to claim 1, wherein
when no cultivation rack which satisfies the condition of the harvest time exists, based on the environmental control information, the processor selects, as the target cultivation rack, at least one cultivation rack in which the growth period is able to be adjusted to satisfy the condition of the harvest time by changing the environmental control condition, and
the processor controls the environmental control equipment under the environmental control condition being changed, to change the environment of the target cultivation rack.

3. The plant management apparatus according to claim 1, wherein
the processor receives the information further indicating a yield of the plant to be harvested in the harvest time, and
the processor selects, as the target cultivation rack, at least one cultivation rack which satisfies conditions of the harvest time and the yield, from among the plurality of cultivation racks.

4. The plant management apparatus according to claim 3, wherein
when no cultivation rack which satisfies the conditions of the harvest time and the yield exists, based on the environmental control information, the processor selects, as the target cultivation rack, at least one cultivation rack in which at least one of the growth period and the yield is able to be adjusted to satisfy the conditions of the harvest time and the yield by changing the environmental control condition, and
the processor controls the environmental control equipment under the environmental control condition being changed, to change the environment of the target cultivation rack.

5. The plant management apparatus according to claim 3, wherein
the processor receives the information further indicating a quality of the plant in addition to the yield of the plant to be harvested in the harvest time, and
based on the environmental control information which further indicates the quality of the plant in addition to the growth period and the yield, the processor selects, as the target cultivation rack, at least one cultivation rack which satisfies conditions of the harvest time, the yield, and the quality, from among the plurality of cultivation racks.

6. The plant management apparatus according to claim 5, wherein
when at least one cultivation rack which satisfies the conditions of the harvest time, the yield, and the quality does not exist, based on the environmental control information, the processor selects, as the target cultivation rack, at least one cultivation rack in which at least one of the growth period, the yield, or the quality is able to be adjusted to satisfy the conditions of the harvest time, the yield, and the quality by changing the environmental control condition, and
the processor controls the environmental control equipment under the environmental control condition being changed, to change the environment of the target cultivation rack.

7. The plant management apparatus according to claim 6, wherein
when the environmental control equipment is controlled to shorten the harvest time, the processor evaluates a quality of the plant as lower by a predetermined rate according to a number of days by which the harvest time of the plant is shortened, determines whether the quality of the plant being evaluated satisfies the condition of the quality, and selects, as the target cultivation rack, at least one cultivation rack capable of satisfying the conditions of the harvest time, the yield, and the quality, and
when the environmental control equipment is controlled to lengthen the harvest time, the processor evaluates the quality of the plant as higher by a predetermined rate according to a number of days by which the harvest time of the plant is lengthened, determines whether the quality of the plant being evaluated satisfies the condition of the quality, and selects, as the target cultivation rack, at least one cultivation rack capable of satisfying the conditions of the harvest time, the yield, and the quality.

8. The plant management apparatus according to claim 6, wherein
when the environmental control equipment is controlled to shorten the harvest time, the processor evaluates a quality of the plant as higher by a predetermined rate according to a number of days by which the harvest time of the plant is shortened, determines whether the quality of the plant being evaluated satisfies the condition of the quality, and selects, as the target cultivation rack, at least one cultivation rack capable of satisfying the conditions of the harvest time, the yield, and the quality, and
when the environmental control equipment is controlled to lengthen the harvest time, the processor evaluates the quality of the plant as lower by a predetermined rate according to a number of days by which the harvest time of the plant is lengthened, determines whether the quality of the plant being evaluated satisfies the condition of the quality, and selects, as the target cultivation rack, at least one cultivation rack capable of satisfying the conditions of the harvest time, the yield, and the quality.

9. The plant management apparatus according to claim 2, wherein when at least one cultivation rack which satisfies the condition of the harvest time does not exist, the processor selects, as a candidate cultivation rack, a cultivation rack in which a harvest time closest to the condition of the harvest time is scheduled, and then selects the candidate cultivation rack as the target cultivation rack when a number of days by which the harvest time of the candidate cultivation rack is to be changed to satisfy the condition of the harvest time is within a predetermined number of days which are adjustable by changing the environmental control condition.

10. The plant management apparatus according to claim 4, wherein when at least one cultivation rack which satisfies the condition of the harvest time does not exist, the processor selects, as a candidate cultivation rack, a cultivation rack in which a harvest time closest to the condition of the harvest time is scheduled, and then selects the candidate cultivation rack as the target cultivation rack when a number of days by which the harvest time of the candidate cultivation rack is to be changed to satisfy the condition of the harvest time is within a predetermined number of days which are adjustable by changing the environmental control condition.

11. The plant management apparatus according to claim 6, wherein when at least one cultivation rack which satisfies the condition of the harvest time does not exist, the processor selects, as a candidate cultivation rack, a cultivation rack in which a harvest time closest to the condition of the harvest time is scheduled, and then selects the candidate cultivation rack as the target cultivation rack when a number of days by which the harvest time of the candidate cultivation rack is to be changed to satisfy the condition of the harvest time is within a predetermined number of days which are adjustable by changing the environmental control condition.

12. The plant management apparatus according to claim 5, wherein the quality includes at least one of a size, a taste, or a shade of color of the plant.

13. The plant management apparatus according to claim 1, wherein the environmental control condition includes a control condition of at least one of a temperature in the plant factory or an amount of light of a light source that radiates light to the plant.

14. A plant management method comprising:
controlling, by a processor and for at least one cultivation rack, environment of a plurality of cultivation racks for cultivating a plant in a plant factory by controlling environmental control equipment which controls an environmental state in the plant factory;
receiving, by the processor, information indicating a harvest time of the plant; and
selecting, by the processor and based on environmental control information indicating a relationship between a growth period and an environmental control condition of the environmental control equipment, at least one cultivation rack which satisfies a condition of the harvest time, as a target cultivation rack, from among the plurality of cultivation racks in which the plant is cultivated in environment controlled by the environmental control equipment under respective environmental control conditions.

15. A non-transitory computer readable medium having recorded thereon a program for causing a computer to perform:
when executed by the computer,
controlling, for at least one cultivation rack, environment of a plurality of cultivation racks for cultivating a plant in a plant factory by controlling environmental control equipment which controls an environmental state in the plant factory;
receiving information indicating a harvest time of the plant; and
selecting, based on environmental control information indicating a relationship between a growth period and an environmental control condition of the environmental control equipment, at least one cultivation rack which satisfies a condition of the harvest time, as a target cultivation rack, from among the plurality of cultivation racks in which the plant is cultivated in environment controlled by the environmental control equipment under respective environmental control conditions.

16. The plant management apparatus according to claim 1, wherein the environmental control condition indicates an hourly set condition of the temperature in the plant factory, and an hourly set condition of the light source during the growth period of the plant.

17. The plant management apparatus according to claim 4, wherein
the processor receives the information further indicating a quality of the plant in addition to the yield of the plant to be harvested in the harvest time, and
based on the environmental control information which further indicates the quality of the plant in addition to the growth period and the yield, the processor selects, as the target cultivation rack, at least one cultivation rack which satisfies conditions of the harvest time, the yield, and the quality, from among the plurality of cultivation racks.

18. The plant management apparatus according to claim 1, wherein when at least one cultivation rack which satisfies the condition of the harvest time does not exist, the processor selects, as a candidate cultivation rack, a cultivation rack in which a harvest time closest to the condition of the harvest time is scheduled, and then selects the candidate cultivation rack as the target cultivation rack when a number of days by which the harvest time of the candidate cultivation rack is to be changed to satisfy the condition of the harvest time is within a predetermined number of days which are adjustable by changing the environmental control condition.

19. The plant management method according to claim 14, comprising;
when no cultivation rack which satisfies the condition of the harvest time exists, based on the environmental control information, selecting, as the target cultivation rack, at least one cultivation rack in which the growth period is able to be adjusted to satisfy the condition of the harvest time by changing the environmental control condition, and
controlling the environmental control equipment under the environmental control condition being changed, to change the environment of the target cultivation rack.

20. A non-transitory computer readable medium according to claim 15 having recorded thereon the program for causing the computer to perform:
when executed by the computer,
when no cultivation rack which satisfies the condition of the harvest time exists, based on the environmental control information, selecting, as the target cultivation rack, at least one cultivation rack in which the growth period is able to be adjusted to satisfy the condition of the harvest time by changing the environmental control condition, and
controlling the environmental control equipment under the environmental control condition being changed, to change the environment of the target cultivation rack.
